(19) United States
(12) Patent Application Publication
(10) Pub. No.: US 2020/0128135 A1
(43) Pub. Date: Apr. 23, 2020

(54) IMAGE INSPECTION APPARATUS AND IMAGE INSPECTION PROGRAM

(71) Applicant: KONICA MINOLTA, INC., Tokyo (JP)

(72) Inventor: Kouichirou MATSUSHITA, Tokyo (JP)

(73) Assignee: KONICA MINOLTA, INC., Tokyo (JP)

(21) Appl. No.: 16/599,361

(22) Filed: Oct. 11, 2019

(30) Foreign Application Priority Data
Oct. 23, 2018 (JP) 2018-199017

(51) Int. Cl. H04N 1/00

(52) U.S. Cl. CPC H04N 1/00018; H04N 1/00015; H04N 1/00135; H04N 1/00037

(57) ABSTRACT

An image inspection apparatus includes a hardware processor that inspects an abnormality of printed matter by comparing a preliminarily prepared answer image with an image obtained by reading a printed image, wherein the hardware processor generates a plurality of answer images based on a combination of pieces of arrangement information on a reusable object and a variable unique object in variable printing.

The entire disclosure of Japanese patent Application No. 2018-199017, filed on Oct. 23, 2018, is incorporated herein by reference in its entirety.

### BACKGROUND

### Technological Field

The present invention relates to an image inspection apparatus and an image inspection program for inspecting an abnormality of printed matter by comparing an image to an image obtained by reading a printed image.

### Description of the Related Art

Paper printed by an image forming apparatus may have an abnormality such as a stain and a scratch of an image due to various reasons.

In order to detect the abnormality, there is a technique for detecting an abnormality by reading paper immediately after being printed with, for example, a scanner. In the technology, first, the first image is printed and scanned to be registered as an answer image. The answer image is compared with the scanning result of an image subsequently printed out. An abnormality is thereby detected.

In recent years, there has been a technique called variable printing. In the variable printing, images different from record by record are generated in accordance with a record value recorded in a database. In recent formats for variable printing, such as PPML and PDF/VT, information on reusability is embedded for each object. A reusable object can make processing time more efficient than a traditional print image format by temporarily storing data after raster image processing (RIP) and reusing the data after the RIP each time the reusable object is drawn after the storage. Inspection of an abnormality of printed matter is required also in such variable printing.

In variable printing, however, a part of an image is different paper by paper. As a result, the comparison to the answer image obtained by scanning the first output image cannot be performed, and image abnormality detecting processing cannot be performed.

In contrast, in JP 2014-146253 A, inspection processing is performed by detecting a reusable object in variable printing, recording an image after RIP as an answer image, and comparing the answer image to RIP result of a reusable object to be used.

In addition, in JP 2012-000876 A, an answer image is generated from information on a reusable (fixed) object and a variable object. The reusable object is treated as a fixed object always arranged in the same place. When the reusable object is arranged in various places page by page, the reusable object is treated as a variable object.

Unfortunately, JP 2014-146253 A discloses just a means for determining whether an RIP result is correct for each reusable object, and does not disclose a configuration for creating an answer image based on information on the arrangement position of the reusable object. Even when there is an abnormality in the subsequent printing processing, the abnormality can thus not be detected.

In JP 2012-000876 A, a variable object region is subject to inspection processing different from that for a fixed object region. Since the inspection accuracy for the variable object region is generally lower than that for the fixed object, the accuracy in the entire output job is lowered.

### SUMMARY

The invention has been made in the context of the above-described circumstances, and an object thereof is to achieve image inspection of a variable print job with high accuracy.

To achieve the abovementioned object, according to an aspect of the present invention, an image inspection apparatus reflecting one aspect of the present invention comprises a hardware processor that inspects an abnormality of printed matter by comparing a preliminarily prepared answer image with an image obtained by reading a printed image, wherein the hardware processor generates a plurality of answer images based on a combination of pieces of arrangement information on a reusable object and a variable unique object in variable printing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 schematically illustrates an image forming system including an image inspection apparatus according to an embodiment of the invention;

FIG. 2 similarly illustrates control blocks of the image forming apparatus including the image inspection apparatus;

FIG. 3 illustrates variable printing;

FIG. 4 illustrates examples of each page on which variable printing is performed;

FIG. 5 illustrates types of answer images in FIG. 4;

FIG. 6 is a table indicating the relationship with an answer image of each page in FIG. 4;

FIG. 7 illustrates a printing example in which a reusable object is exhibited;

FIG. 8 illustrates printing examples of each page in which a reusable object is exhibited;

FIG. 9 illustrates types of answer images in FIG. 8;

FIG. 10 illustrates printing examples of each page in which a plurality of reusable objects is exhibited;

FIG. 11 illustrates types of answer images in FIG. 10;

FIG. 12 is a table indicating the relationship with an answer image of each page in FIG. 10;

FIG. 13 illustrates printing examples of each page assuming double-sided printing;

FIG. 14 illustrates types of answer images in FIG. 13;

FIG. 15 illustrates printing examples of each page assuming imposition printing;

FIG. 16 illustrates a printing example in which a reusable object and a variable unique object overlap; and

FIG. 17 is a flowchart illustrating the procedure of inspection processing in an embodiment of the invention.

### DETAILED DESCRIPTION OF EMBODIMENTS

Hereinafter, one or more embodiments of the present invention will be described with reference to the drawings. However, the scope of the invention is not limited to the disclosed embodiments.

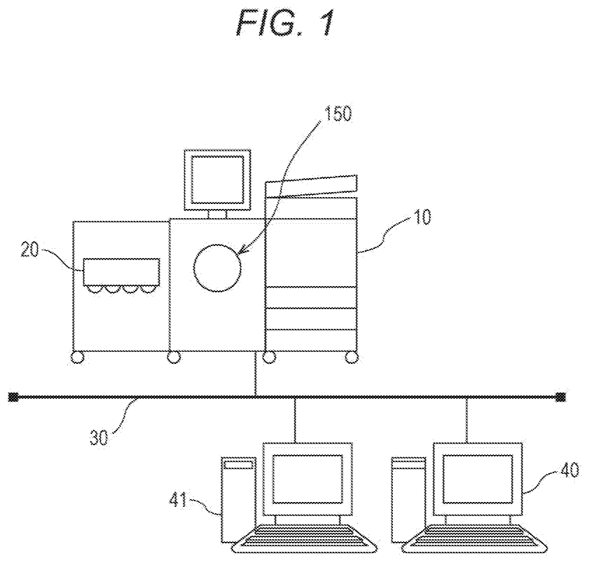

FIG. 1 illustrates an image forming system 1. The image forming system 1 is connected to an image forming apparatus 10 and client terminals 40 and 41 by a communication line 30. The image forming apparatus 10 forms an image on a recording medium by electrophotography. In the embodiment, paper is used as the recording medium. The storage medium is not limited to paper, and may include cloth and plastic. The material of the storage medium is not particularly limited.

Although a communication network such as a local area network (LAN) and a wide area network (WAN) can be used as the communication line 30, contents of the communication line in the invention are not particularly limited and the communication line 30 may include a serial cable.

The image forming apparatus 10 includes an image forming unit 150 and an image inspection apparatus 20. The image forming unit 150 prints an image on paper. The image inspection apparatus 20 includes an output object reader 190, and is incorporated downstream of the image forming unit 150. The image inspection apparatus 20 detects an abnormality by scanning an image printed on a recording medium and comparing the scanned image to an answer image.

It should be noted that, in the above-described embodiment, the image inspection apparatus 20 is described as including the output object reader 190, but the image inspection apparatus may acquire a reading result from the output object reader without the output object reader in the image inspection apparatus.

In the above-described embodiment, the image forming apparatus 10 is described as including the image inspection apparatus 20, but the image inspection apparatus may be equipped regardless of the image forming apparatus. The image inspection apparatus may be equipped as an external apparatus, or equipped in, for example, the client terminal or a server. In short, the image inspection apparatus is only required to get a reading result of printed paper and compare the reading result to an answer image. The installation location is not particularly limited.

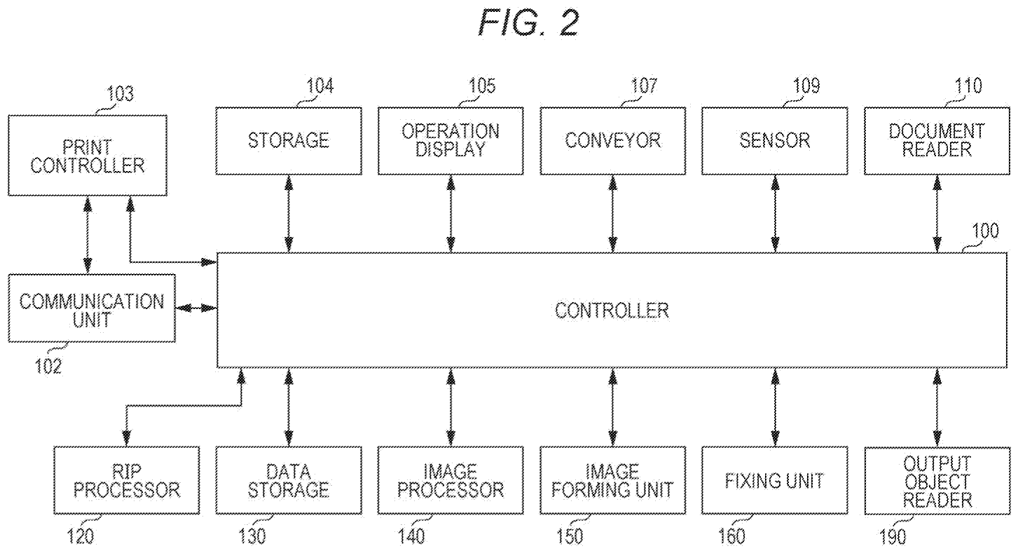

Control blocks of the image forming apparatus 10 will now be described with reference to FIG. 2.

The image forming apparatus 10 includes a controller 100, a communication unit 102, a print controller 103, a storage 104, an operation display 105, an image formation conveyor 107, a sensor 109, a document reader 110, an RIP processor 120, a data storage 130, an image processor 140, an image forming unit 150, a fixing unit 160, and an output object reader 190.

The controller 100 controls each component in the image forming apparatus 10.

The controller 100 can include a central processing unit (CPU), a memory such as a read only memory (ROM) and a random access memory (RAM), a hard disk drive (HDD). The controller 100 decompresses a program stored in the ROM or the HDD in the RAM, and executes the program with the CPU. The HDD may also store, for example, layout data, which specifies the arrangement of objects in variable printing, and image data before rasterization.

In the controller 100, a program is executed. An image inspection program of the invention is operated in part of the controller 100. A read image can be inspected for abnormality. Consequently, in the embodiment, the controller 100 functions as an image inspection controller of the invention. It should be noted that, although, in the embodiment, the function of the image inspection controller is described as being executed by the controller 100 that controls the entire image forming apparatus, an image inspection controller may be prepared as being different from the controller that controls tire image forming apparatus, may be provided in the image inspection apparatus to be used only for image inspection, and may be provided in, for example, the client terminal or the server.

The communication unit 102 communicates with another set apparatus (e.g., external device). The print controller 103 receives job data written in a page description language from the external device, and stores the received job data as necessary.

The storage 104 stores, for example, various settings and programs.

The operation display 105 receives an operation input from a user, and displays the status of the image forming apparatus 10.

The image formation conveyor 107 conveys paper in the apparatus. The sensor 109 detects various states of the paper regarding image formation and paper conveyance. The document reader 110 reads an image of a document with an imaging device to generate document image data.

The RIP processor 120 executes RIP processing on job data before RIP processing. The job data has been received by the print controller 103, and is written in the page description language. The RIP processor 120 converts the job data into image data in a bitmap format. An image can be formed with the image data.

The data storage 130 stores image data for image formation and various pieces of data. It should, be noted that the data storage 130 includes an image memory for reading and an image memory for printing. The image memory for reading receives image data. The image memory for printing outputs the received image data for image formation. Information on, for example, reusable objects and variable unique objects in variable printing may be stored in the image memory for reading. An answer image used for comparison in image inspection can also be stored in the data storage 130.

The image processor 140 executes various types of image processing necessary for image formation. The image forming unit 150 forms an image on paper based on an image formation command and image data stored in the image memory for printing in the data storage 130.

The fixing unit 160 stabilizes the image, which has been formed on the paper with toner, by heat and pressure.

The output object reader 190 reads the image on the paper, and generates read image data.

Although the image forming unit 150 may form an image in a plurality of colors, this is not limitative, and the image forming unit 150 may form a monochrome image. Various structures can be considered for paper feeding, image formation, and paper ejection. FIG. 1 illustrates one example of the image forming system, the image forming apparatus, and the image inspection apparatus. The configuration and form illustrated in the specific example are not limitative.

### First Embodiment

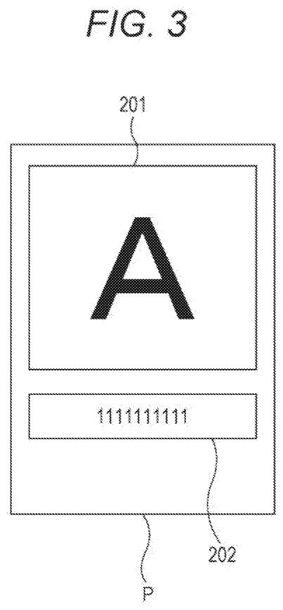

Variable printing performed in an image forming apparatus 10 will be described with reference to FIG. 3,

FIG. 3 illustrates an example of variable printed matter used in the invention. Paper P has been printed. An image of each page contains a reusable object region 201 and a variable unique object region 202. The reusable object is used repeatedly. The variable unique object is an object whose content is variable at a unique arrangement position.

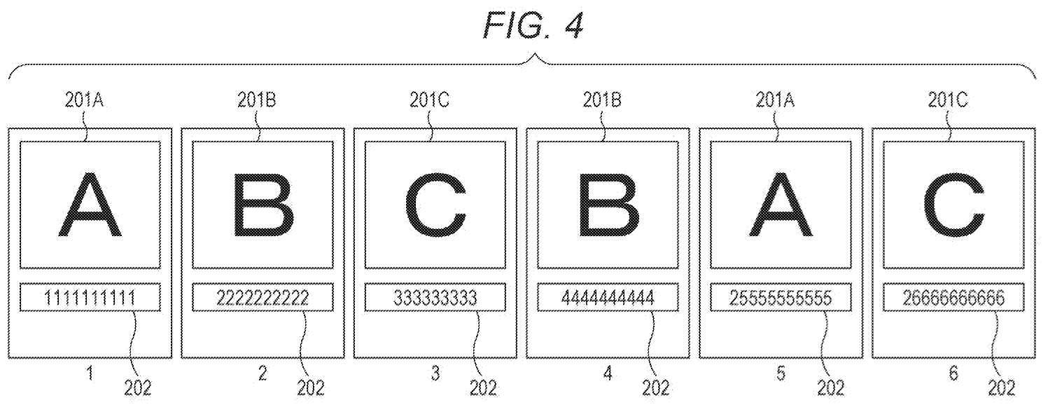

FIG. 4 illustrates an example of an output result arranged in the page order in the example of FIG. 3. One of images of reusable object regions 201A, 201B and 201C, which respectively include images of three types A, B, and C, is arranged in the place corresponding to the reusable object in FIG. 3. The variable unique object region 202 of an image, which is used only once in the previous page, is applied to the variable unique object in FIG. 3.

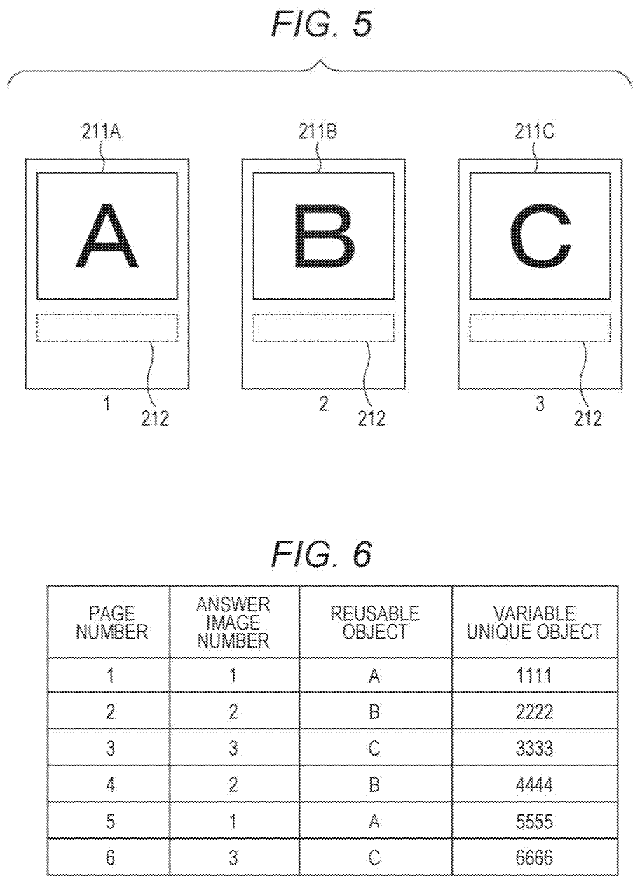

FIG. 5 illustrates the types of exemplary answer images in the printing example in FIG. 4. Three types are exhibited in combinations of arrangement information on the reusable object and the variable unique object in FIG. 4, and answer images are generated in accordance with the number of types.

A variable unique object region 212, which is used only once in the job in FIG. 4, has only attribute information corresponding to the variable unique object in the answer image, and is blank as image information.

Each of repeatedly used reusable object regions 211A, 211B, and 211C has image information and attribute information.

At the time of inspection processing, whether there is a difference is determined by printing answer image data and comparing scanned images of the reusable object regions 201A, 201B and 201C to the reusable object regions 211A, 211B, and 2110 of the answer images.

An inspection processing different from that for the reusable object region is performed in the variable unique object region. Examples of the different processing here include processing such as comparison not to a scanned answer image but with an image after RIP, comparison to a record value in a database that has been used at the time of generating a variable print job, and performing no inspection processing.

FIG. 6 illustrates a table in which answer images in respective pages are associated. The table is recorded in the image forming apparatus. Inspection processing is performed by comparison to answer images at the time of outputting the images of the respective pages.

The answer images have a different number for each page. The contents of the reusable object and the variable unique object are determined for each page.

### Second Embodiment

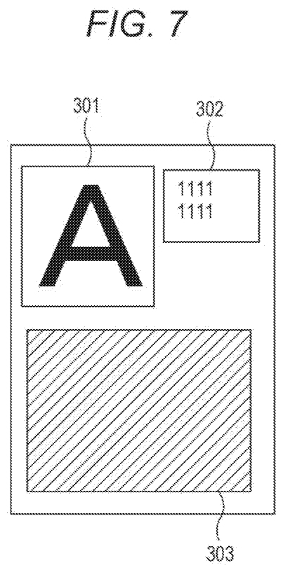

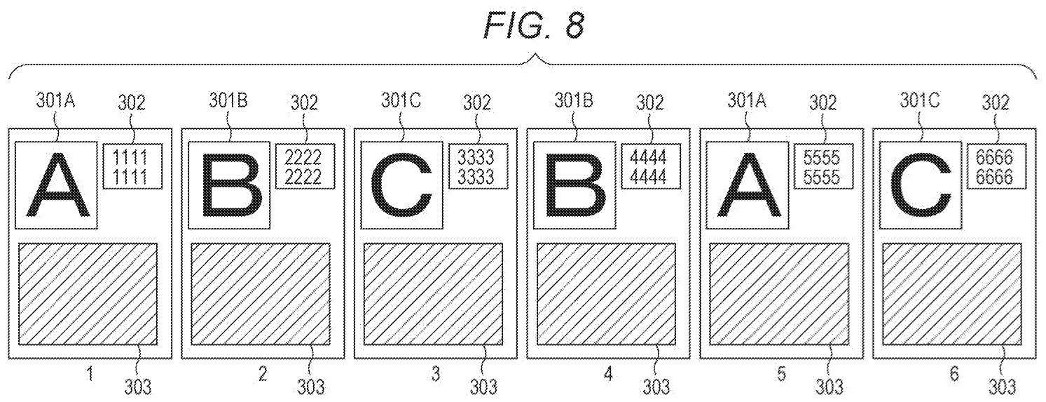

FIG. 7 illustrates an example in which a reusable object region 303, which is arranged in common to all pages, is arranged in addition to a reusable object region 301 and a variable unique object region 302 in FIG. 3. The reusable object region 301 is variable.

FIG. 8 illustrates an example of an output result arranged in the page order in the example of FIG. 3. The reusable object region 301 includes a reusable object regions 301A, 301B, and 301C depending on variable contents.

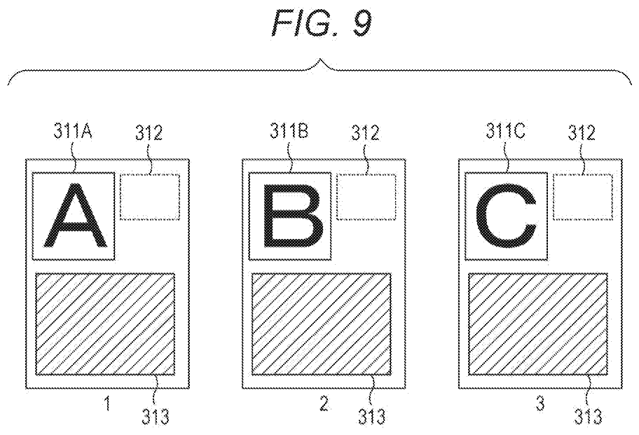

FIG. 9 illustrates examples of the answer images in the example of FIG. 8. In the embodiment, a reusable object region 313, which is arranged in common to all pages, is arranged in a lower portion of a page in addition to the form of the first embodiment, and the arrangement information of the embodiment does not influence the number of answer images. Three types of answer images are generated similarly to the first embodiment. Reusable object regions 311A, 311B, and 311C and a variable unique object region 312 are arranged.

### Third Embodiment

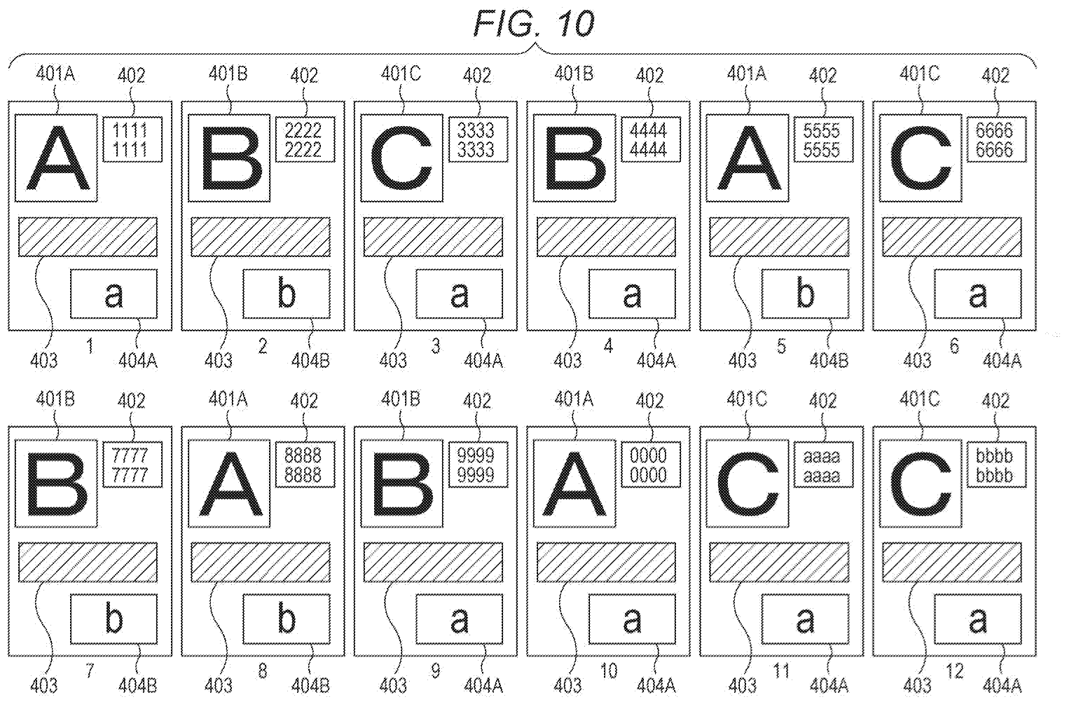

FIG. 10 illustrates an example of a job in which a plurality of variable reusable objects is arranged. In addition to variable reusable object regions 401A, 401B, and 401C of three types of “A”, “B”, and “C”, in the first and second embodiments, arranged in an upper portion of a page, variable reusable object regions 404A and 404B of two types of “a” and “b” are arranged in a lower portion of the page. A variable unique object region 402 and a reusable object region 403 are also arranged. The reusable object region 403 is used in common to all pages.

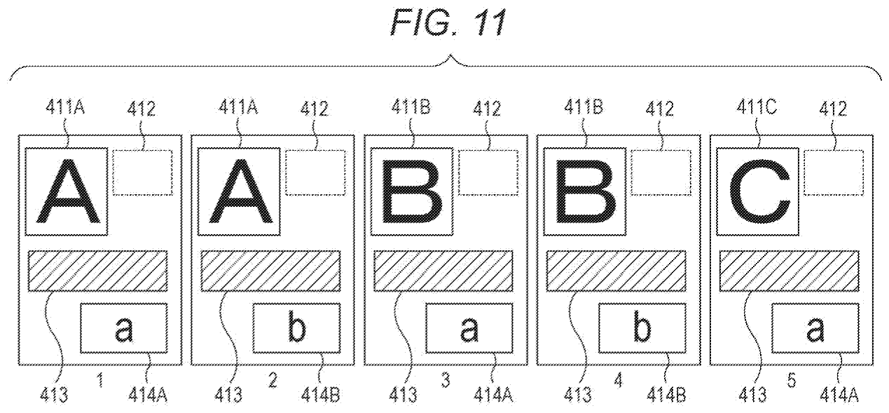

FIG. 11 illustrates examples of the answer images in the example of FIG. 10. Answer images are generated for the number of combinations of two types of variable reusable objects. In FIG. 10, 3×2=6 types of answer images are possible for a job of 12 page. The combination of “C” and “b”, however, are not exhibited in FIG. 10. Consequently, five types of combinations are generated as answer images while the combination of “C” and “b” is eliminated. That is, variable reusable object regions 411A, 411B, and 411C, a variable fixed object region 412, a reusable object region 413, and variable reusable object regions 414A and 414B are arranged in the answer images.

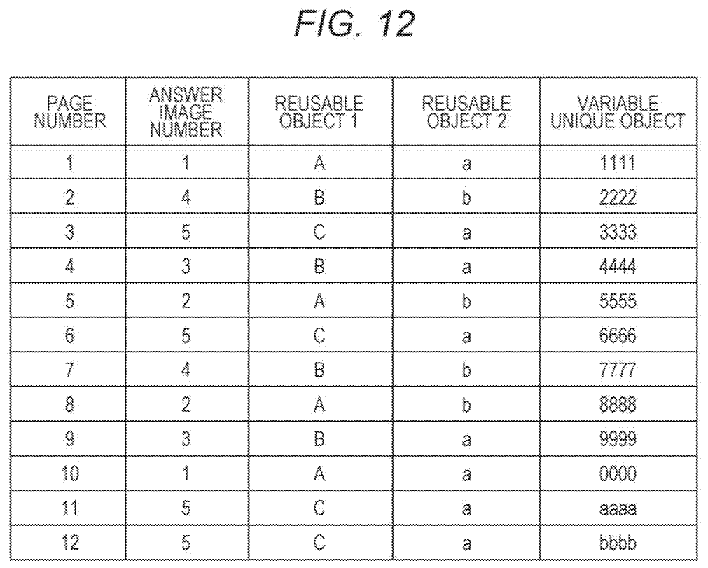

FIG. 12 illustrates a table in which an output image of each page and an answer image in the embodiment are associated. Answer images are exhibited in accordance with the number of combinations of the variable reusable object regions 411A, 411B, and 411C and the variable reusable object regions 414A and 414B.

### Fourth Embodiment

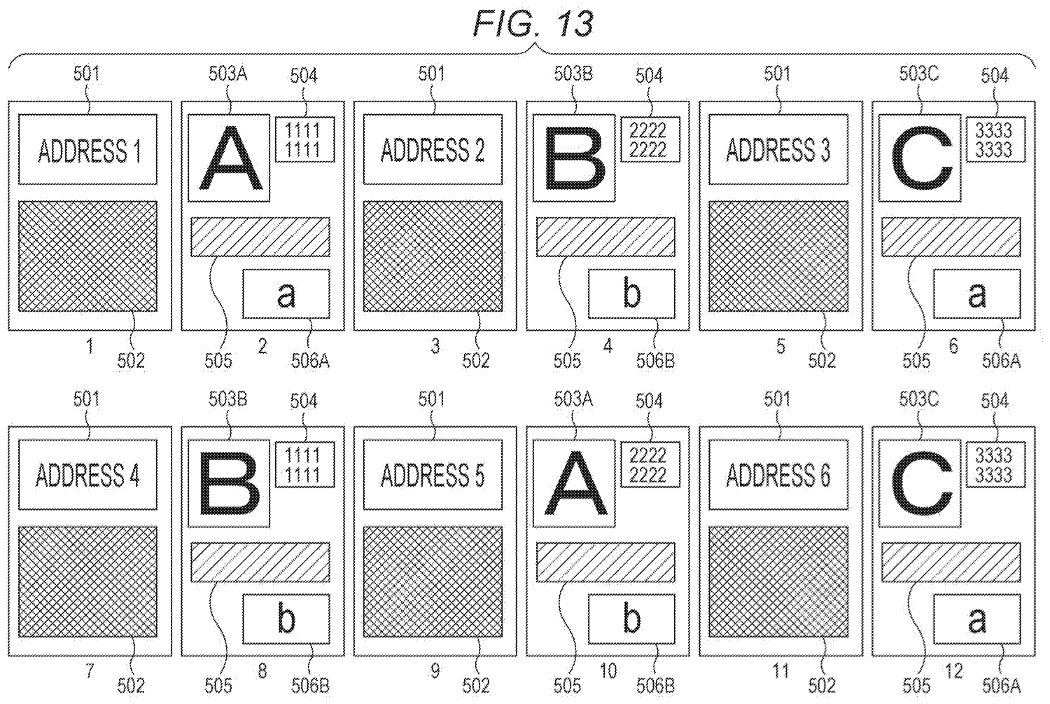

FIG. 13 illustrates an example of variable printing assuming double-sided printing. Variable printing is often used for direct mail. In the case, an address is printed on the front, and an individual advertisement for an individual is printed on the back. In shots, the layout is significantly changed for each page, such as addresses are in odd pages and advertisements are in even pages.

In each page, a variable unique object region 501 and a reusable object region 502 are arranged in an odd page, and variable reusable object regions 503A, 503B, and 503C, a variable unique object region 504, a reusable object region 505, variable reusable object regions 506A and 506B are arranged in an even page.

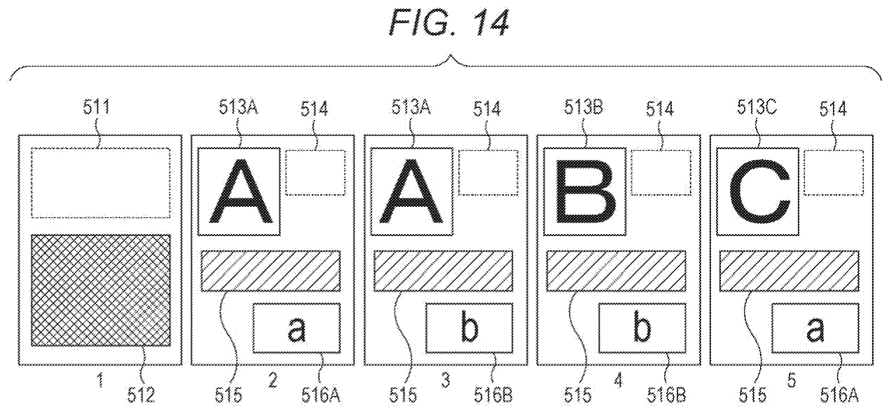

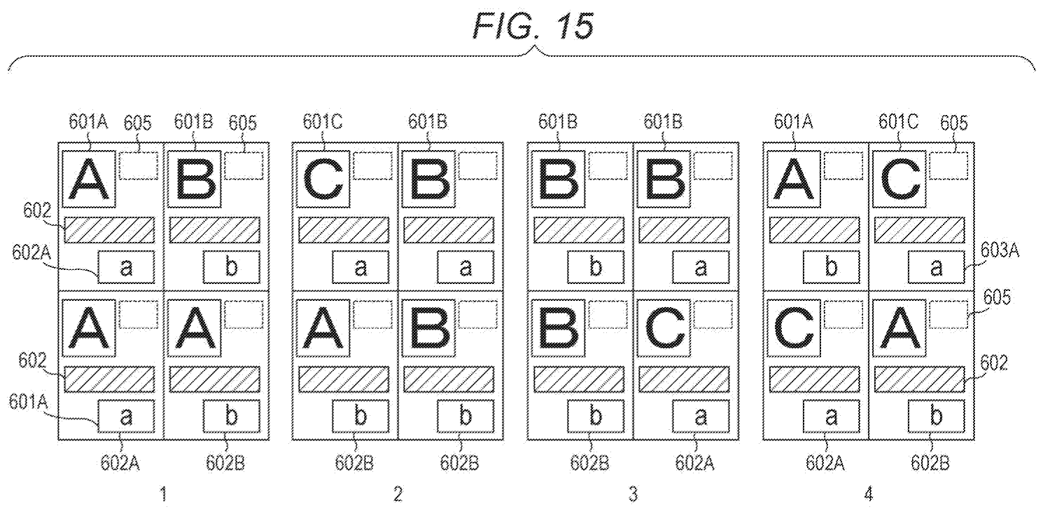

FIG. 14 illustrates examples of the answer images in the example of FIG. 13. Only one type of answer image of the address page (odd page in FIG. 13) is exhibited since the arrangement condition of the reusable object is not changed. That is, a variable unique object region 511 and a reusable object region 512 are arranged contrast, four types (number of patterns of object combinations in an even page in FIG. 13) of answer images are generated depending on the way of thinking similar to that in the third embodiment since the arrangement condition of the reusable object is changed for each page in advertisement pages (even pages in FIG. 13). The above-described number of combinations is added, and five (1+4) types of answer images are exhibited in the embodiment. That is, variable reusable object regions 513A, 513B, and 513C, a variable unique object region 514, a reusable object region 515, and variable reusable object regions 516A and 516B are arranged.

### Fifth Embodiment

FIG. 15 illustrates an example of the answer images at the time of imposition output. In variable printing, a final output result is often paper of relatively small size such as direct mail and an advertisement. In such a case, it is considered to impose the final output result on large paper, output the imposed result, and finally cut the paper. In the embodiment, answer images of the same number of imposition patterns in the case are generated. More specifically, two types of variable reusable objects (“A, B or C” and “a orb”) are arranged in an image before imposition. Up to six types of combination patterns are possible here. One page has four imposed objects in the embodiment, and thus up to 24 (=6×4) types of combinations are possible. Only combination pattern to be actually printed is extracted from the combinations to generate an answer image. Reusable object regions 601A, 601B, and 601C, a variable unique object region 602, and reusable object regions 603A and 603B are arranged in each page.

### Sixth Embodiment

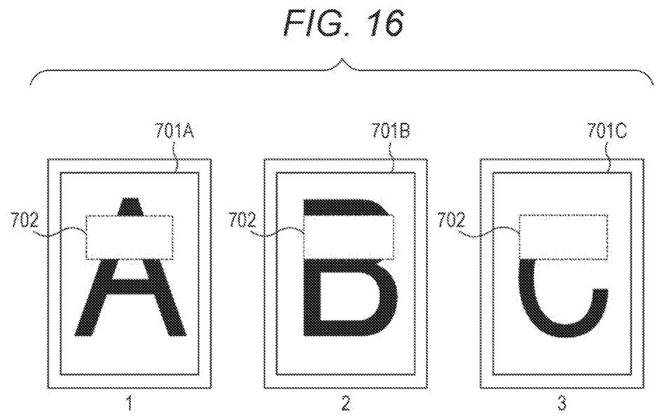

FIG. 16 illustrates an example in which a reusable object and a variable unique object overlap.

In the embodiment, each of three types: “A”, “B” and “C” of reusable object regions 701A, 701B and 701C is arranged on the entire surface of each page. A blank object region 702 surrounded by a broken line indicates a variable unique object. The object region 702 is superimposed on the reusable object regions. Although a part of the reusable object is arranged below the broken-line region, the entire region is subject to inspection processing as the variable unique object region.

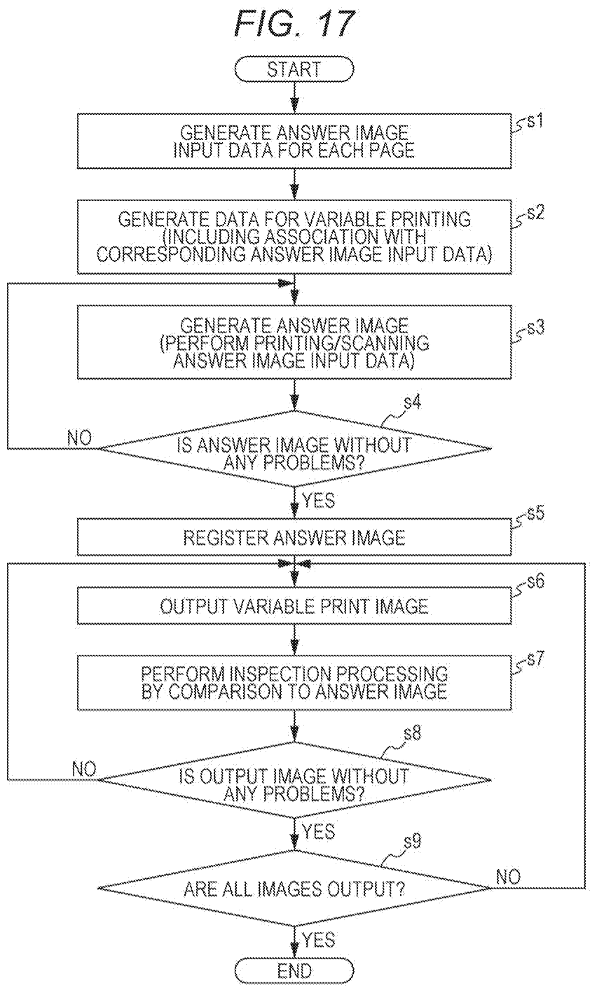

FIG. 17 illustrates the flow of processing in the embodiment. The following processing is executed under control of an image inspection controller.

When the processing is started, answer image input data for each page is generated (step s1).

In the above-described step, layout data of all pages is read, and the arrangement information on a reusable object and a variable unique object is extracted. The layout data may be read on layout generating application software for variable printing, and may be read at the timing immediately before performing RIP on a variable printing format (e.g., PPML and PDF/VT) with a printer (controller). The variable printing format is generated on the above-described application.

Arrangement patterns for each page are calculated based on these pieces of arrangement information, and answer image data is generated by the number of the arrangement patterns. More specifically, when a plurality of images is arranged as the reusable objects with respect to the same object region of each page, answer image data is generated by the number of the arranged images. When a plurality of regions is exhibited, answer images are generated for the number of combinations. Meanwhile, when variable (unique) objects are arranged in the same object region of each page, the number of answer images is not influenced.

Data for variable printing is generated, and associated with the corresponding answer image input data (step s2). That is, generation processing (RIP) for variable print data is performed on each page, and association with the answer images is performed in the step.

It should be noted that, in generating the variable print data, a layout is specified by a print instruction from a user. In order to assign each image to the specified layout, a record is extracted from, for example, a customer database, and applied to a layout frame. The image is mapped to a field whose layout has been designated, and the variable print data is generated. The processing is repeated until composition of one page is completed.

When the composition of one page is completed, for example, identification information for identifying printed matter and a file name of an image that has been mapped to each field are barcoded and added to the variable print data so as to compose the page. The processing is repeated until, for example, the customer database is finished.

A character and an image that have been registered as a variable object are inserted into a variable region. A character that has been registered as a reusable object is inserted in a fixed character region. An image that has been registered as a reusable object is inserted into a fixed image region. Other regions are blank.

Only an answer image is printed out, and a result obtained by scanning the result is confirmed (step s3). The output of answer images is repeated until a user can determine that there is no problem (step s4).

When the user determines that the image that has been printed out has no problem, the image is registered as an answer image (step s5).

It should be noted that the registration of an answer image is not limited to a specific method. For example, an image that has already been used for printing and has no abnormality in inspection processing may be used.

A type of setting may be performed. In the setting, a preview of an image scanned at the time of creating the answer image is displayed, a variable region is manually set on the display screen, and no inspection processing is performed.

After the above-described processing is completed, the output of variable printing is formally started (step s6). After outputting each page, an image is scanned and compared to the preliminarily associated answer image (step s7).

Following the result of the comparison, it is determined whether the output image has a problem (step s8). It should be noted that whether the output image has a problem can be determined by an appropriate determination method, and the determination method in the invention is not limited to a specific method. For example, whether a defect is on paper can be determined by detecting difference by comparing a read image to an answer image and being based on the detection result of the difference. In addition, instead of determining all parts where difference has been detected as defects, a part having difference exceeding a threshold value set by the user can be determined as a defect.

When the output image has no problem (Yes in step s8), it is determined whether all images have been output (step s9). When not all images have been output (No in step s9), the processing proceeds to step s6, and the next page is printed. When an abnormality is detected (No in step s8), the processing proceeds to step s6, and the page is output again. The processing is repeated until a normal output is performed.

These pieces of processing are repeated until all pages are output. When all pages are output (Yes in step s9), all pieces of processing are completed.

In the embodiment, the above-described variable region can be automatically set. In addition, the inspection accuracy of a repeatedly used variable object can be improved by comparing the variable object to the print-out scanned image.

In variable printing, even when the same reusable object is used, the adhesion characteristics of toner or ink change depending on the position of paper to be primed, and slight difference is caused by how light hits a scanner at the time when an answer image is created. In the embodiment, the user views a print result first. An image that has been determined as having no problem in quality is stored as an answer image and used for comparison. Consequently, abnormality during printing can be detected.

Although embodiments of the present invention have been described and illustrated in detail, the disclosed embodiments are made for purposes of illustration and example only and not limitation. The scope of the present invention should be interpreted by terms of the appended claims. Appropriate changes to the above-described embodiments can be made without departing from the scope of the invention.

What is claimed is:

1. An image inspection apparatus comprising a hardware processor that inspects an abnormality of printed matter by comparing a preliminarily prepared answer image with an image obtained by reading a printed image,
wherein the hardware processor generates a plurality of answer images based on a combination of pieces of arrangement information on a reusable object and a variable unique object in variable printing.

2. The image inspection apparatus according to claim 1, wherein the hardware processor determines the number of answer images by reading arrangement information on an object in all pages.

3. The image inspection apparatus according to claim 1, wherein the image inspection apparatus creates the answer image by reading arrangement information on an object in all pages.

4. The image inspection apparatus according to claim 3, wherein the hardware processor reads arrangement information on an object in all pages at a time of generating input data for variable printing or performing RIP on the data.

5. The image inspection apparatus according to claim 1, wherein the answer image is obtained by printing answer image data generated based on a combination of pieces of arrangement information on a reusable object and reading the printed image.

6. The image inspection apparatus according to claim 1, wherein the answer mage is obtained by printing answer image data generated based on a combination of pieces of arrangement information on a reusable object by the number of the generated pieces of answer image data and reading the printed image by the number.

7. The age inspection apparatus according to claim 1, wherein the hardware processor inspects an abnormality of printed matter by associating a corresponding answer image among a plurality of answer images with an output image of each page and performing image comparison.

8. The image inspection apparatus according to claim 1, wherein an answer image has attributes of a reusable object region and a variable unique object region, and the hardware processor changes a content of inspection processing in each image region.

9. The image inspection apparatus according to claim 8, wherein the hardware processor treats all regions where a reusable object and a variable unique object overlap as variable unique object regions.

10. The image inspection apparatus according to claim 1, further comprising an image reader that reads a printed image.

11. A non-transitory recording medium storing a computer readable image inspection program to be executed at a hardware processor that inspects an abnormality of printed matter by comparing a preliminarily prepared answer image with an image obtained by reading a printed image,
wherein the program causes the hardware processor to execute generating a plurality of answer images based on a combination of pieces of arrangement information on a reusable object and a variable unique object in variable printing.

12. The non-transitory recording medium storing a computer readable image inspection program according to claim 11, causing the hardware processor to execute creating the answer image by reading arrangement information on an object in all pages.
